(19) United States
(12) Patent Application Publication
(10) Pub. No.: US 2010/0227225 A1
(43) Pub. Date: Sep. 9, 2010

(54) SOLVENT COMPOSITION AND ELECTROCHEMICAL DEVICE

(75) Inventor: Haruki Segawa, Kanagawa-ken (JP)

Correspondence Address: 3M INNOVATIVE PROPERTIES COMPANY, PO BOX 33427, ST. PAUL, MN, 55133-3427, US

(73) Assignee: 3M INNOVATIVE PROPERTIES COMPANY, Saint Paul, MN (US)

(21) Appl. No.: 12/279,558

(22) PCT Filed: Feb. 5, 2007
(86) PCT No.: PCT/US2007/003180

§ 371 Date: Aug. 15, 2008

(30) Foreign Application Priority Data
Feb. 28, 2006 (JP) 2006-053233

(51) Int. Cl. H01M 6/16; B01F 1/00

(52) U.S. Cl. 429/324; 252/364

(57) ABSTRACT

To provide a solvent composition that exhibits non-volatility, non-flammability, thermal stability, chemical stability and high ion conductivity, is excellent in high rate charge/discharge characteristics, is free from the drop of performance at low temperatures and can function as a non-aqueous electrolyte in electrochemical devices. Solvent composition comprising an ionic liquid and a halogenated solvent, which has a halogenation degree of 87% or below and contains at least one partially halogenated alkyl group and/or at least one partially halogenated alkylene group, and in which the solvent composition is under a single phase and in an uniform condition at 25° C.

### TECHNICAL FIELD

This invention relates to an ionic liquid and its usage, more particularly, it relates to a solvent composition comprising an ionic liquid in combination with a specific halogenated solvent, and an electrochemical energy device using the solvent composition as non-aqueous electrolyte such as a lithium type secondary cell.

### BACKGROUND

An ionic liquid (also called “normal temperature molten salt”) has an increasing attention as a novel medium in place of water and organic solvents. Though it is an ionic compound, that is, a salt, the ionic liquid has a low melting point and is liquid in the proximity of normal temperature. Although a clear definition has not been given to the ionic liquid, salts having a melting point of 100° C. or below are generically regarded as the ionic liquid. The ionic liquid generally has features of non-volatility, non-flammability, thermal stability, chemical stability and high ion conductivity. Further, it has been proposed to use the ionic liquid for various applications by utilizing these features. Especially, intensive studies have been made to use the ionic liquid as a reaction solvent for organic synthesis and electrolytic synthesis and also as an electrolyte for electrochemical energy devices (hereinafter called “electrochemical device”) such as a lithium ion cell.

When used as the non-aqueous electrolyte of the electrochemical device, the ionic liquid has considerably higher viscosity than that of non-aqueous solvents used for ordinary electrochemical devices. Therefore, performance such as high rate charge/discharge characteristics (charge/discharge characteristics observed when a discharge rate is set to approximately 1.0 C; also called “high rate charge/discharge characteristics”) and low temperature performance are not sufficient and the ionic liquid cannot be used satisfactorily for practical application. It may be possible to improve these characteristics by selecting and using an ionic liquid having a relatively low viscosity, on the other hand, but such an ionic liquid is not generally electrochemically stable. In consequence, degradation of cycle characteristics of the devices may occur and in the worst cases, charging or discharging in the initial stage cannot be made. To solve the problems, various ionic liquids and compositions containing them have already been proposed as will be concretely explained in the following paragraphs.

Patent Reference Japanese Unexamined Patent Publication (Kokai) No. 2004-146346 (Claims, Paragraphs 0136 to 0142) describes a non-aqueous electrolyte comprising an ionic liquid having a melting point of 50° C. or below, a compound that can be reduced and decomposed at a nobler potential than the ionic liquid, and a lithium salt, and also a secondary cell that uses the non-aqueous electrolyte. In the case of this non-aqueous electrolyte, the low temperature characteristics and stability are improved by improving the ionic liquid used itself. The ionic liquid used is the one the cation part of which is a quaternary ammonium or quaternary phosphonium and contains at least one alkoxyalkyl group. In Example 13, the patent reference 1 describes a secondary cell that uses lithium cobalt oxide as a positive electrode active material and MCMB for a negative electrode active material. The electrolyte used in this secondary cell is prepared by dissolving 29 parts by weight of lithium salt (lithium trifluoromethanesulfonimde) in 71 parts by weight of an ionic liquid (N,N-diethyl-N-methyl-N-(2-methoxyethyl)ammonium bis(trifluoromethanesulfonyl)imide and adding further 10 parts by weight of vinylene carbonate. As for the charge/discharge characteristics of this secondary cell, when the discharge capacity at the time of a discharge rate 0.1 C is set to 100%, a capacity of 95% or more is maintained within the range of 0.5 C but the capacity drops down to 56.4% at a high rate discharge of 1.0 C (see, Table 3 of the reference). Incidentally, the drop of the capacity to 56.4% was acceptable in around 2002, but this value cannot satisfy the requirement for current secondary cells.

Patent Reference Japanese Unexamined Patent Publication (Kokai) No. 2004-362872 (Claims, Paragraphs 0016 to 0022, 0028) describes a rechargeable device comprising an electrolyte for the rechargeable device, containing a normal temperature molten salt (ionic liquid) and a fluorine type solvent having a viscosity lower than that of the molten salt, and a pair of electrodes. The fluorine type solvent used has features in that the solvent is a compound containing at least one fluorine atom and at least one oxygen atom in the molecule; its potential window includes the range of 0 to 4.5 V (Li/Li⁺); and it is an organic solvent containing at least 10 mass % of fluorine atoms in a mass ratio, as described in the claims. The reference illustrates, as concrete examples of the fluorine type solvent, 4-ethylfluorobenzene (hereinafter called “compound 1” for convenience sake; hereinafter the same), 3-fluoroaniline (compound 2), 1,1,7,7-tetrafluoroheptane (compound 3), and so forth. However, the flash point of the compound 2 is 77° C. and non-flammability as the merit of the normal temperature molten salt may be lost. The flash points of the compounds 1 and 3 are not known but are believed to be likewise low because the fluorine substitution ratio is extremely small. When mixed with the normal temperature salt, they may have the demerit in the same way as the compound 2. On the other hand, methyl-nona-fluorobutylether and ethyl-nonafluorbutylether may be conceivable as the compounds capable of satisfying the requirements of the claims, though their concrete examples are not given, but these ethers are not miscible with the normal temperature molten salt having alkylammonium or imidazolium as the cation in the single phase homogeneous state.

Patent Reference Japanese Unexamined Patent Publication (Kokai) No. 2005-135777 (Claims, Paragraphs 0038, 0045, 0046) describes a non-aqueous electrolyte containing at least one kind of normal temperature molten salt as its constituent component, wherein the non-aqueous electrolyte contains an organic solvent which has the property of either one of (1) and (2) and is liquid at normal temperature;

(1) boiling point of 100° C. or above and no flash point, and

(2) flash point or decomposition starting temperature of 200° C. or above.

The organic solvent satisfying the requirements includes fluorocarbons and phosphate esters having an aromatic ring. The example of the non-aqueous electrolyte includes the following.

### Electrolyte 1

Mixture of 0.5 L (litter) of ethylmethylimidazolium tetrafluoroborate (EMIBF₄) as the normal temperature molten salt, 1 mol of LiBF₄ and 0.5 L of fluorocarbon “Fluorinert™ FC-40 (trade name; product of Sumitomo 3M).

### (Electrolyte 2)

Mixture of 0.5 L of EMIBF₄ as the normal temperature molten salt, 1 mol of LiBF₄ and 0.5 L of fluorocarbon “Fluorinert™ FC-43 (trade name; product of Sumitomo 3M).

However, when the inventor of the present invention has attempted the reproduction test, the non-aqueous electrolyte having each composition described above cannot be mixed uniformly by customary means such as mixing, stirring and heating. The non-aqueous electrolyte should remain under the uniform and single phase state because it forms the site for exchanging the electrons on the interface with the electrodes in the electrochemical devices such as the lithium ion cell.

### SUMMARY

It is an object of the invention to provide a solvent composition that exhibits non-volatility, non-flammability, thermal stability, chemical stability and high ion conductivity, is excellent in high rate charge/discharge characteristics, is free from the drop of performance at low temperatures and degradation of cycle characteristics of devices, and can function as a non-aqueous electrolyte in electrochemical devices.

It is another object of the invention to provide an electrochemical device that uses such a solvent composition as the non-aqueous solvent, is excellent in high rate charge/discharge characteristics, is free from the drop of performance at low temperatures, is further excellent in electrochemical stability and is free from degradation of cycle characteristics of devices.

These and other objects of the invention will be easily understood from the following detailed explanation.

The inventor of this invention has found that one or more of the objects described above can be accomplished when the ionic liquid is used in combination with a specific halogenated solvent, instead of using the ionic liquid alone as in the prior art. The present invention provides a solvent composition comprising an ionic liquid and a halogenated solvent, wherein:

the ionic liquid has a molecular structure in which a cation and an anion are contained as form a pair, and its melting point is 100° C. or below;

the halogenated solvent contains at least a fluorine atom as a halogen atom, has a halogenation degree or ratio (defined as a proportion of the sum of the number of the fluorine atoms and the number of other halogen atoms (when present) to the sum of the fluorine atoms, other halogen atoms and hydrogen atoms in a molecule as a whole) of not greater than 87% and contains at least one partially halogenated alkyl group and/or at least one partially halogenated alkylene group; and

the solvent composition is under a single phase and in an uniform state at 25° C.

The present invention resides also in an electrochemical device containing the solvent composition according to the invention as a non-aqueous solvent.

As will be appreciated from the following detailed explanation, the invention can acquire a solvent composition that can be advantageously used in various fields inclusive of the utilization as a reaction solvent in organic synthesis and electrolytic synthesis and electrochemical devices such as lithium ion cells.

The solvent composition according to the invention does not contain water and is especially useful as a non-aqueous electrolyte (also called “non-aqueous electrolyte solution”). When used in electrochemical devices, this non-aqueous electrolyte can sufficiently exhibit various properties originating from the ionic liquid used as the first constituent component, such as non-volatility, non-flammability, thermal stability, chemical stability and high ion conductivity without lowering their levels.

Further, because a specific halogenated solvent is used as the second constituent component in combination with the ionic liquid and because the resulting composition is under the single phase and uniform liquid state, remarkable functions and effects that the single use of the ionic liquid cannot achieve can be accomplished. For example, the non-aqueous electrolyte can improve high rate charge/discharge characteristics and low temperature characteristics as the demerits of the single use of the ionic liquid, can improve also electrochemical stability of devices and does not substantially spoil non-flammability as the feature of the ionic liquid when achieving these improvements.

Furthermore, the electrochemical device according to the invention, typically a lithium type cell, can be used stably for a long period while keeping high performance because its electrolyte has excellent characteristics as described above.

### BRIEF DESCRIPTION OF THE DRAWINGS

FIG. 1 is a sectional view showing a preferred example of a coin type lithium ion cell according to the invention.

FIG. 2 is a graph prepared by plotting the relation between the number of cycles and a discharge capacity in Example C1 and Comparative Example C1.

FIG. 3 is a graph prepared by plotting the relation between the number of cycles and a discharge capacity in Example C2 and Comparative Example C2.

FIG. 4 is a graph prepared by plotting the relation between the number of cycles and a discharge capacity in Example C3 and Comparative Examples C3-1 and C3-2.

FIG. 5 is a graph prepared by plotting the relation between the number of cycles and a discharge capacity in Example C4 and Comparative Examples C4-1 and C4-2.

FIG. 6 is a graph prepared by plotting the relation between the number of cycles and a discharge capacity in Example C5 and Comparative Examples C5-1 and C5-2.

FIG. 7 is a graph prepared by plotting the relation between the number of cycles and a discharge capacity in Example C6 and Comparative Example C6.

### DETAILED DESCRIPTION OF THE EMBODIMENTS

The solvent composition according to the invention is characterized in that it contains the ionic liquid as the first constituent component and a specific halogenated solvent as the second constituent component. The ionic liquid is constituted by an organic compound having a molecular structure in which a cation and an anion are contained as a pair and the melting point of the ionic liquid is 100° C. or below. The ionic liquid may be used alone or in combination of two or more kinds. The ionic liquid used in the invention may be organic compounds that are generally known as the ionic liquid in the prior art.

The ionic liquid that can be advantageously used in the practice of the invention is an organic compound in which the cation has a ring-like or chain-like structure. The ring-like or chain-like structure preferably contains at least one atom of a different kind, particularly, a nitrogen atom and/or a sulfur atom. More preferably, the ionic liquid satisfies either one, or both, of the following requirements:

the nitrogen or sulfur atom is contained in a center of the cation; and

the compound has a heterocyclic structure.

More concretely, the cation contained in the ionic liquid can be preferably expressed by either one of the following structural formulas C-1 to C-5, though not particularly limited thereto. The structural formulas C1-1 and C-2 represent the example of the cation having the chain structure and the structural formulas C-3 to C-5 represent the example of the cation having the ring-like structure such as the heterocyclic structure.

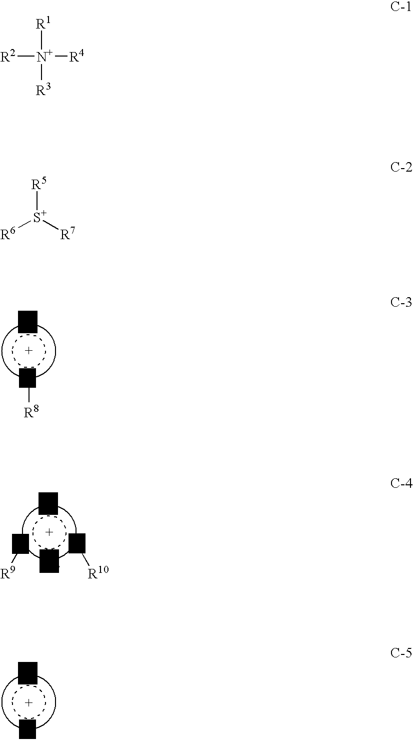

In the formula given above, the substitution groups R¹ to R¹⁰ may be the same or different and each independently represents a hydrogen atom or a saturated or unsaturated alkyl group having 1 to 12 carbon atoms (C1 to C12). These substitution groups may have ether bond oxygen, whenever necessary. Among the substitution groups R¹ to R¹⁰, those existing inside the same molecule may be a C1 to C12 saturated or unsaturated alkylene group whose carbon atoms combine with one another and form a ring.

Q₁ to Q₄ may be the same or different and each independently represents a plurality of atom groups capable of forming a ring with atoms of different kinds such as a nitrogen atom, a sulfur atoms, and so forth, and preferably represents a C1 to C12 saturated or unsaturated alkylene group. Q₁ to Q₄ may further have an additional ring structure outside the branched structure or the heterocyclic structure.

The cation contained in the ionic liquid can preferably be expressed by either one of the following structural formulas C-6 to C-16.

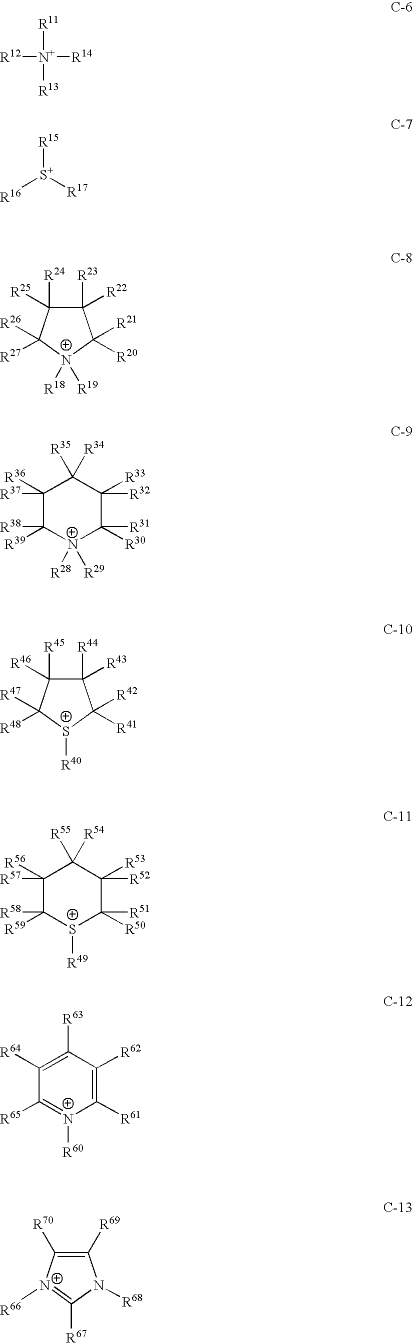

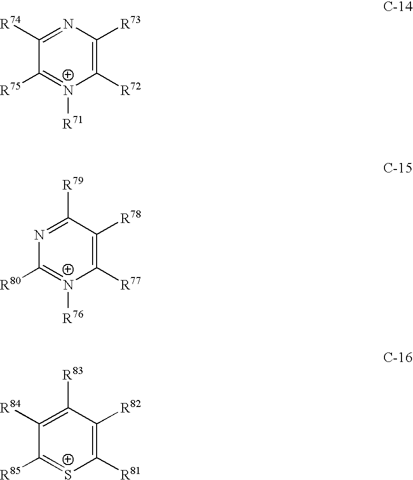

In the formulas given above, the substitution groups R¹¹ to R⁸⁵ may be the same or different and each independently represents a hydrogen atom or a C1 to C12 saturated or unsaturated alkyl group. These substitution groups may have ether bond oxygen, whenever necessary. Among the substitution groups R¹¹ to R⁸⁵, those existing inside the same molecule may be a C1 to C12 saturated or unsaturated alkylene group that bond to one another and form a ring.

Further, in the ionic liquid according to the invention, the anion contained as a member forming the pair with the cation can be preferably expressed by any of the following general formulas A-1 to A-3, though not particularly limited thereto.

(Rf₁SO₂)(Rf₂SO₂)N (A-1)

In the formula given above, Rf₁ and Rf₂ may be the same or different and each independently represents a C1 to C4 straight chain or branched chain fluorinated alkyl group. Among the substitution groups Rf₁ and Rf₂, those existing inside the same molecule may be a C1 to C8 straight chain or branched chain fluorinated alkylene groups that bond to one another to form a ring.

(Rf₃SO₂)(Rf₄SO₂)(Rf₅SO₂)C⁻ (A-2)

In the formula given above, Rf₃, Rf₄ and Rf₅ may be the same or different and each independently represents a C1 to C4 straight chain or branched chain fluorinated alkyl group. Among the substitution groups Rf₃, Rf₄ and Rf₅, those existing inside the same molecule may be C1 to C4 straight chain or branched chain fluorinated alkylene groups that bond to one another to form a ring.

Rf₆SO₃⁻

In the formula given above, Rf₆ represents a C1 to C8 straight chain or branched chain fluorinated alkyl group.

In the practice of the invention, it is possible to use a variety of ionic liquids having molecular structures in which the cation described above or other arbitrary preferred cations form pairs with the anion described above or other arbitrary preferred anions. Typical examples of the ionic liquids suitable for the practice of the invention include the following organic compounds, though the invention is not limited thereto:

| cation | anion |
|---|---|
| 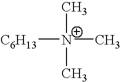 | 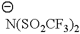 |
| 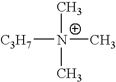 | 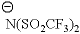 |
| 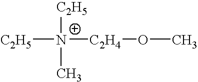 | 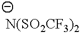 |
| 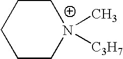 | 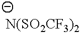 |
| 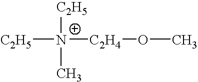 | 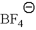 |
| 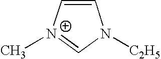 | 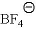 |

In each example of the ionic liquids given above, the cation and the anion can be replaced by other cations and anions described in the columns of cation and anion, respectively. Alternatively, they may be replaced by other cations and other anions described in “cation group” and “anion group” described below, whenever necessary.

### Cation Group

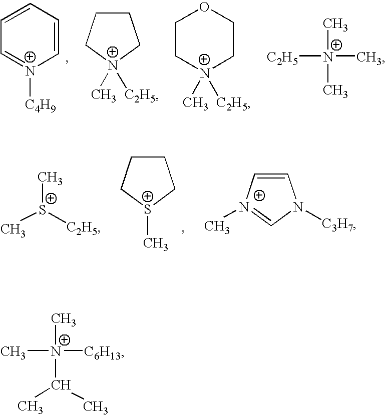

and others.

### Anion Group

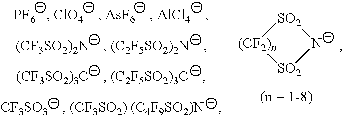

and others.

In the solvent composition according to the invention, the specific halogenated solvent used in combination with the ionic liquid described above is a halogenated compound that contains at least a fluorine atom as a halogen atom and additionally contains at least one halogen atom selected from the group consisting of a bromine atom, a chlorine atom and an iodine atom (these halogen atoms will be called “other halogen atoms” in the invention), whenever necessary. In such a halogenated compound, a halogenation degree or ratio (defined as a proportion of the total number of the fluorine atoms and other halogen atoms with respect to the total number of the fluorine atoms, other halogen atoms (when they are present) and the hydrogen atoms in the molecule as a whole) is about 87% or below. This halogenated compound further contains at least one partially halogenated alkyl group and/or at least one partially halogenated alkylene group. These halogenated solvents may be used either alone or in combination of two or more kinds. Incidentally, the term “halogen” in the invention represents a fluorine atom, a bromine atom, a chlorine atom or an iodine atom, unless specifically specified otherwise.

The specific halogenated solvent includes various halogen compounds that satisfy the requirements described above. The halogenated compounds suitable for the practice of the invention include the following compound (a) to (d), through not particularly limited thereto.

(a) Compound of formula R₁OR₂

In the formula given above, R₁ and R₂ may be the same or different and each independently represents a straight chain or branched chain alkyl group or partially halogenated alkyl group of C1 to C10. R₁ and R₂ may further contain ether bond oxygen, whenever necessary. Incidentally, the halogen atom of the halogenated alkyl group is selected from the group consisting of the fluorine atom, the chlorine atom, the iodine atom and the bromine atom.

(b) Compound of formula R₃O(R₄O)ₚ(R₅O)_{q}R₆

In the formula given above, R₃ and R₆ may be the same or different and each independently represents a straight chain or branched chain alkyl group or partially halogenated alkyl group or completely halogenated alkyl group of C1 to C10.

R₄ and R₅ may be the same or different and each independently represents a straight chain or branched chain alkylene group or partially halogenated alkylene group or completely halogenated alkylene group of C1 to C10. Incidentally, the halogen atom of the halogenated alkyl group and the halogenated alkylene group is selected from the group consisting of the fluorine atom, the chlorine atom, the iodine atom and the bromine atom.

Symbols p and q may be the same or different and each independently represents 0 or an integer of 1 to 10 with the proviso that p and q are not 0 simultaneously.

(c) Compound of formula A(OR₇)m

In the formula given above, R₇ independently represents a straight chain or branched chain alkyl group, partially halogenated alkyl group or completely halogenated alkyl group of C1 to C10. Whenever necessary, R₇ may further contain ether bond oxygen. Incidentally, the halogen atom of the halogenated alkyl group is selected from the group consisting of the fluorine atom, the chlorine atom, the iodine atom and the bromine atom.

Symbol A represents a divalent to tetravalent hydrocarbon group, partially halogenated hydrocarbon group or completely halogenated hydrocarbon group of C1 to C8. Whenever necessary, A may further contain an ether bond oxygen.

Symbol m is an integer of 2 to 4.

(d) Partially halogenated, straight, branched or cyclic alkanes having at least 4 carbon atoms. Incidentally, the halogen atom is selected from the group consisting of the fluorine atom, the chlorine atom, the iodine atom and the bromine atom.

When used for the preparation of the electrolyte of the electrochemical devices such as the lithium ion cell, the halogenated solvent improves cycle efficiency of the electrodes and non-flammability of the solvent component and lowers the viscosity of the solvent component. The halogenation degree of the halogenated solvent is about 87% or below but its lower limit is not restrictive. The halogenation degree of the halogenated solvent is preferably within the range of about 50 to about 87% and more preferably within the range of about 57 to about 85% to limit ignition property of the halogenated solvent to a low level. When the halogenation degree is less than 50%, the flame retarding effect is likely to drop and when it exceeds 87%, compatibility with the non-aqueous electrolyte constituent components other than the halogenated solvent is likely to drop.

Typical examples of the halogenated solvents suitable for the practice of the invention include the following halogenated compounds, though not limited thereto.
CF₃CFHCF₂OC₂H₄OCF₂CFHCF₃;
CF₃CFHCF₂OCH₂CH(CH₃)OCF₂CFHCF₃;
CF₃CFHCF₂O(CH₂)₃OCF₂CFHCF₃;
CF₃CFHCF₂OCH(CH₃)CF₂CFHCF₃;
CF₂HC₅F₁₀OCH₃;
CF₂HC₇F₁₄OCH₃;
C₃F₇OC₂F₃HOC₂H₄OC₂F₃HOC₃F₇;
CF₃CFHCF₂OCH₂CH(OCF₂CFHCF₃)CH₂OCF₂CFHCF₃;
CF₂HCF₂OC₂H₄OCF₂CF₂H;
CF₂HCF₂CH₂OCF₂CFHCF₃;
CCIFHCF₂OC₂H₄OCF₂CCIFH;
CF₃(CFH)₂CF₂CF₃;
1,1,2,2,3,3,4-heptafluorocyclopentane; and others.

The solvent composition according to the invention is generally and essentially constituted from the ionic liquid and the halogenated solvent described above, but may additionally contain a third constituent component, whenever necessary. The third constituent component includes an aprotic solvent. The aprotic solvent can further improve solubility of a support electrolyte used in combination when the solvent composition of the invention is used for the preparation of the non-aqueous electrolyte, and can lower the viscosity of the electrolyte. When a greater amount of the halogenated solvent is blended to improve the cell performance, too, a greater amount of the aprotic solvent can be advantageously added. Concrete examples of the aprotic solvent include chain-like carbonate esters expressed by the formula RxOCOORy (where Rx and Ry may be the same or different and each independently represents a straight chain or branched chain C1 to C4 alkyl group), cyclic carbonate esters such as propylene carbonate, ethylene carbonate, vinylene carbonate and the like, γ-butyrolactone, 1,2-dimethoxyethane, diguraim, tetraguraim, tetrahydrofuran, alkyl-substituted tetrahydrofuran, 1,3-dioxolan, alkyl-substituted 1,3-dioxolan, tetrahydropyran and alkyl-substituted tetrahydropyran.

In the solvent composition according to the invention, the proportion of the ionic liquid and the halogenated solvent can be varied in a broad range depending upon the application of the solvent composition and the desired improvement of performance. Generally, however, the content of the halogenated solvent is about 80 vol % or below on the basis of the sum of the ionic liquid and the halogenated solvent and is preferably within a range of about 5 to about 75% from the aspects of compatibility and other characteristics. When the content of the halogenated solvent exceeds 80 vol %, the improvement of the rate characteristics and the low temperature characteristics cannot be observed. When the content of the halogenated solvent exceeds 80 vol %, ion dissociation of the ion dissociable compounds (lithium salt, for example) dissolved is suppressed and the rate characteristics and the low temperature characteristics cannot be improved or get worse even if a stable and uniform non-aqueous electrolyte can be obtained and can be kept as such.

The solvent composition according to the invention can be used for various applications. For example, the solvent composition of the invention can be applied to the organic reaction. Concrete examples of the organic reaction include an organic synthesis reaction and a polymerization reaction. In other words, the solvent composition of the invention can be advantageously used as a reaction medium such as a catalyst in the organic reactions.

The solvent composition according to the invention can also be applied to electrochemical devices. In other words, the solvent composition of the invention or the composition prepared by further adding a support electrolyte to the solvent composition can be advantageously used as a non-aqueous electrolyte in the electrochemical devices. Examples of the electrochemical devices to which the solvent composition of the invention can be applied include lithium cells, lithium ion cells, lithium polymer cells, electric double layer capacitors, hybrid type electrochemical energy devices (for example, devices comprising, in combination, an electrode capable of charging electricity based on an electric double layer capacitor and an electrode capable of charging electricity based on a Faraday capacitor), pigment sensitization solar cells and electro-chromic devices, though they are not particularly restrictive.

In the specification of this application, an application example of the present invention was described principally referring to a lithium type cell. Further, in the explanation of the lithium type cell, an example in which a support electrolyte such as a lithium salt (as a third component) was added to the “ionic liquid and specific halogenated solvent” which are the basic components of the solvent composition of the present invention, i.e., an electrolyte composition comprising at least three components, was referred to in the production of the lithium type cell. However, when the device of the present invention is directed to an electric double layer capacitor, ionic species contained in the electrolyte composition used therein should not be restricted to lithium ions. Any optional ionic species capable of producing an electric double layer in an interface between the electrodes may be contained in the electrolyte composition. In such a case, the ionic liquid itself can be dissociated to anions and cations, and thus can also act as the support electrode. Of course, any additive may be added to the electrolyte composition to further improve the properties of the composition. The additive may be those capable of forming a lithium ion.

The solvent composition of the invention can be used especially advantageously as the non-aqueous electrolyte in the electrochemical devices such as the lithium type cells. When the solvent composition of the invention is used as the non-aqueous electrolyte, the support electrolyte is further added to the solvent composition. The support electrolyte is preferably an ion dissociable compound as will be explained next, and the ion dissociable compound is preferably lithium salts.

Moreover, when the solvent composition of the invention is used as the non-aqueous electrolyte in the electrochemical devices such as the lithium type cells, other additives are preferably contained. When the solvent composition is used as the non-aqueous electrolyte of the lithium type cells, ring-like carbonate esters such as ethylene carbonate (EC) or vinylene carbonate (VC) is preferably contained. The cell characteristics may be further improved by adding additives for the surface modification of the positive electrode and/or the negative electrode and an additive for improving stability.

As described above, the solvent composition of the invention can be used advantageously as the non-aqueous electrolyte in the electrochemical devices such as the lithium type cells. To have the invention more fully understood, the use of the solvent composition of the invention will be explained with reference to a coin type lithium ion cell shown in FIG. 1. Note that the lithium ion cell shown in the drawing represents an example of the invention and the electrochemical devices of the invention are not limited thereto.

A lithium ion cell 10 has a shape of a small disk, for example, and may have the same construction as that of conventional coin type lithium ion cells with the exception that it uses the solvent composition according to the invention as the non-aqueous electrolyte. The lithium ion cell 10 has a construction in which its functional portion (single cell) is encompassed by a positive electrode can 1 on the lower side and a negative electrode can 2 on the upper side, and the cell 10 is hermetically sealed by a gasket 8 interposed between these electrode cans. The positive electrode 4 includes coating applied to an aluminum foil 3 as a current collector and is isolated from the negative electrode (lithium) 6 by a separator 5 made of glass filter. The non-aqueous electrolyte of the invention is applied between the positive electrode 4 and the negative electrode 6 though it is not shown in the drawing. A spacer 7 formed of stainless steel is brought into contact with the negative plate 6 and is urged by a wave washer 9. In consequence, the functional portion can be stably held.

In the lithium type cell according to the invention, the single cell constituting the functional portion includes the electrodes (a pair of positive and negative electrodes), the non-aqueous electrolyte and the separator. Each constituent element will be hereinafter explained.

### Electrodes

In the practice of the invention, the positive and negative electrodes used as the electrodes are not particularly limited and can be constituted by electrode active materials used ordinarily in the field of the lithium type cells. The observation acquired by the inventor of this invention has revealed that compounds for the electrodes are not particularly limited as long as they can execute oxidation-reduction of the lithium seed but the compound for the positive electrode can preferably generate oxidation-reduction of the lithium seed at 1.5 V or above, more preferably 3.0 V or above, with lithium as the reference. Examples of the active material for the positive electrode are composite oxides containing lithium and at least one kind of transition metal element. More concretely, they are composite oxides of lithium and a transition metal having phyllo-crystalline structure expressed by LiₐNi_{b}Co_{c}Mn_{d}O₂ (0.8=<a=<1.2, 0=<b=<1, 0=<c=<1, 0−<d=<1), composite oxides of lithium and metals having a spinel structure and composite oxides of lithium and metals having an olivine structure. Organic sulfur type compounds can be used for the positive electrode active material, too.

On the other hand, the materials for the negative electrode are those that can execute oxidation-reduction of the lithium seed at 1.5 V or below, more preferably 1.0 V or below, with lithium as the reference. Examples of the negative electrode active material include carbon materials, lithium, alloys containing lithium and those compounds which form alloys with lithium. More concretely, they are carbon materials such as natural graphite, artificial graphite, hard carbon, meso phase carbon micro-beads and fibrous graphite, metallic lithium, metals capable of forming alloys with lithium such as aluminum, silicon and tin, and their alloys. Among them, metallic lithium is particularly suitable as the negative electrode active material because it has theoretically the greatest energy density.

### Non-Aqueous Electrolyte

The non-aqueous electrolyte includes at least the solvent composition of the invention (the repeated explanation of the solvent composition will be omitted herein) and the lithium salt support electrolyte. The solvent composition of the invention can improve compatibility of the electrolyte component. The non-aqueous electrolyte may optionally contain additives capable of contributing to the improvement of the characteristics, whenever necessary.

The lithium salt support electrolyte may be those which have generally been used in the past for the lithium type cells, and includes, for example, organic lithium salts, inorganic lithium salts and their mixtures. Concrete examples of the organic lithium salts include organic sulfoneimide salts of lithium such as lithium bis(pentafluoroethanesulfone)imide (LiBETI) (Sumitomo 3M, “Fluorad FC-130” or “Fluorad L-13858”), lithiumbis(trifluoromethanesulfone)imide (LiTFSI) (Sumitomo 3M, “Fluorad HQ-115” or “Fluorad HQ-115J”), lithiumbis(nonafluorobutanesulfone)imide (LiDBI), etc, and organic sulfonemethide salts of lithium such as lithiumtris(trifluoromethanesulfone)methide (LiTFM). On the other hand, examples of the organic salts include lithium hexafluorophosphate (LiPF₆). These organic and inorganic lithium salts may be used either alone or as mixtures of two or more kinds. Of course, the inorganic lithium salt and the organic lithium salt may be used in combination with one another, it desired. Here, the lithium organic salt has high solubility in the solvent component and can form an electrolyte having a high concentration. On the other hand, the inorganic lithium salt such as lithium hexafluorophosphate (LiPF₆) is more economical than the organic lithium salt but is hardly soluble in the solvent component in some cases. Therefore, when the lithium salt support electrolyte contains the inorganic salt, it is recommended that the solvent composition according to the invention further contains an aprotic solvent.

In the non-aqueous electrolyte according to the invention, the lithium salt support electrolyte can be used in various concentrations depending on desired characteristics. The concentration of the lithium salt support electrolyte is generally within the range of 0.1 to 2 mol/L.

Other solvent components and additives may be added to the non-aqueous electrolyte within the range in which the function and effect of the invention is not lost. Examples of suitable additives include cyclic carbonate esters as the negative electrode modifiers such as ethylene carbonate (EC) and vinylene carbonate (VC), ethylene sulfite and propane sultone, and the positive electrode modifier such as biphenyl and cyclobenzene. The non-aqueous electrolyte of the invention may be converted to the corresponding gel polymer electrolyte by adding a polymer compound thereto.

In the lithium type cell according to the invention, a separator is used between the positive electrode and the negative electrode to prevent contact and short-circuit between the positive electrode and the negative electrode and to hold the non-aqueous electrolyte. The separator is generally constituted by a porous or finely porous thin film. Examples of the material suitable for the separator include glass and polyolefines.

In the lithium type cells using the non-aqueous electrolyte of the invention, charging can be made at a high rate. In other words, even when charging is made at a relatively large current within a short time, a practical capacity can be acquired in subsequent discharge of the cell. The lithium type cell of the invention is excellent in high rate discharge characteristics, too. When discharge continues at a relatively large current such as a continuous speech by a mobile telephone, for example, a practical usable time can be extended. Therefore, the lithium type cell of the invention can exhibit suitable performance in the application in which the maximum value of charge and/or discharge is made at a current of 1.0 CmAh or above where CmAh is the capacity of the smaller one of the positive electrode capacity and the negative electrode capacity calculated from the weight of the respective electrode active material.

The lithium type cell using the non-aqueous electrolyte of the invention is excellent also in the charge/discharge characteristics at low temperatures. In other words, the lithium type cell can acquire a practical charge capacity even when charging is made at a low temperature, the loss is small during storage and the usable time becomes longer at the time of discharge. Furthermore, because the non-aqueous electrolyte of the invention is excellent in stability, the charge/discharge/storage characteristics of the lithium type cell at high temperatures can be improved. Therefore, the lithium type cell according to the invention can be charged, discharged or stored at an ambient temperature of 0° C. or below or at an ambient temperature of 45° C. or above.

The non-aqueous electrolyte according to the invention can improve the cycle characteristics of the cell because it can improve charge/discharge efficiency of the electrodes. In other words, the lithium type cell according to the invention can maintain the cell capacity when charge/discharge is repeated more than 10 times, at a high level for a long time.

The solvent composition according to the invention can be advantageously used as the electrolyte in electric double layer capacitors, in addition to the usage as the electrolyte in the lithium type cells described above. The construction of this electric double layer capacity can be basically the same as that of the electric double layer capacitors of the prior art but in the case of the electric double layer capacitor according to the invention, a material having a large effective surface area such as active carbon can be used as the electrode material of both electrode (positive and negative electrodes).

Alternatively, it is possible to constitute a hybrid type capacitor having a capacitor operation in combination with a cell operation by adding further a lithium salt to the solvent composition of the invention containing the ionic liquid and the halogenated solvent, using the resulting composition as the electrolyte, and using active carbon for one of the electrodes and a material which the lithium ion can be fitted to and removed from, such as graphite, for the other electrode.

When the solvent composition of the invention is used as the electrolyte in the electric double layer capacitor, other solvent components and additives may be added to the non-aqueous electrolyte within the range in which the function and effect of the invention is not lost, in the same way as in the case of the cells described above.

### EXAMPLES

Subsequently, the invention will be explained with reference to examples thereof. Note, however, that the invention is in no way limited by these examples.

### Preparation of Non-Aqueous Electrolyte

Non-aqueous electrolytes having different compositions were prepared by using the following ionic liquids, halogenated solvents, additives, and so forth, to use them in the examples and comparative examples. Incidentally, identification symbols inside parentheses after chemical formulas and chemical names were abbreviations assigned for the ease of explanation. Distributor names and product names of compounds were put in the “Note” section of the table when such compounds were commercially available.

### Ionic Liquid

N,N,N-trimethyl-N-hexylammonium bis(trifluoromethanesulfon)imide (TMHA)
N,N-diethyl-N-methyl-N-(2-methoxyethyl)ammonium bis(trifluoromethanesulfon)imide (DEME)
N,N,N-trimethyl-N-propylammonium bis(trifluoromethanesulfon)imide (TMPA)
N-methyl-N-propylpiperidinium bis(trifluoromethanesulfon)imide (PP13)
N,N,-diethyl-N-methyl-N-(2-methoxyethyl)ammonium tetrafluoroborate (DEMEB)
1-ethyl-3-methylimidazorium tetrafluoroborate (EMIB)

### Halogenated Solvent

| Chemical formula (identification symbol) | Note |
|---|---|
| CF₃CFHCF₂OC₂H₄OCF₂CFHCF₃ (FS-1) | |
| CF₃CFHCF₂OCH₂CH(CH₃)OCF₂CFHCF₃ (FS-2) | |
| CF₃CFHCF₂O(CH₂)₃OCF₂CFHCF₃ (FS-3) | |
| CF₃CFHCF₂OCH(CH₃)CF₂CFHCF₃ (FS-4) | |
| CF₂HC₅F₁₀OCH₃ (FS-5) | |
| CF₂HC₇F₁₄OCH₃ (FS-6) | |
| C₃F₇OC₂F₃HOC₂H₄OC₂F₃HOC₃F₇ (FS-7) | |
| CF₃CFHCF₂OCH₂CH(OCF₂CFHCF₃)CH₂OCF₂CFHCF₃ (FS-8) | |
| CF₂HCF₂OC₂H₄OCF₂CF₂H (FS-9) | |
| CF₂HCF₂CH₂OCF₂CFHCF₃ (FS-10) | |
| CCIFHCF₂OC₂H₄OCF₂CCIFH (FS-11) | |
| CF₃(CFH)₂CF₂CF₃ (FS-12) | Vertrel XF [DuPont] |
| 1,1,2,2,3,3,4-heptafluorocyclopentane (FS-13) | Zeorora H [Nippon Zeon] |
| (for Comparative Examples) | |
| C₄F₉OC₂H₅ (CFS-1) | HFE7200 [3M] |
| (C₄F₉)₃N (CFS-2) | FC-40 [3M] |
| C₆F₁₄ (CFS-3) | FC-72 [3M] |
| CF₂H(OC₂F₄)ₓ(OCF₂)_{y}OCF₂H (CFS-4) | H-Galden ZT150 [Solvay Solexis] |
| CH₃OC₆F₁₂OCH₃ (CFS-5) | |

### Additives and Others

| Chemical name (identification symbol) | Note |
|---|---|
| ethylene carbonate (EC) | |
| vinylene carbonate (VC) | |
| lithium bis(trifluorometharesulfone)imide (LiTFSI) | HQ-115 [3M] |

The following table illustrates the halogenation degree (%) and the existence/absence of the partially halogenated alkyl group or the partially halogenated alkylene group for each of various halogenated solvents described above. Incidentally, the technical leaflet of the distributor describes that the molecular weight of the halogenation degree of CFS-4 as the halogenated solvent for the comparative example is 572. Therefore, the conditions of x and y (refer to the chemical formula given above) substantially satisfying this molecular weight were calculated and the numerical value was calculated from the range of the number of fluorine atoms (F) in the molecular structure determined from the calculation.

| | Halogenated solvent | | | | | | |
|---|---|---|---|---|---|---|---|
| | FS-1 | FS-2 | FS-3 | FS-4 | FS-5 | FS-6 | FS-7 |
| Halogenation degree | 66.7 | 60.0 | 60.0 | 66.7 | 75.0 | 80.0 | 76.9 |
| (%) | | | | | | | |
| Partially halogenated | Yes | Yes | Yes | Yes | Yes | Yes | Yes |
| alkyl and/or alkylene | | | | | | | |
| group | | | | | | | |

| | Halogenated solvent | | | | | |
|---|---|---|---|---|---|---|
| | FS-8 | FS-9 | FS-10 | FS-11 | FS-12 | FS-13 |
| Halogenation degree | 69.2 | 57.1 | 71.4 | 57.1 | 83.3 | 70.0 |
| (%) | | | | | | |
| Partially | Yes | Yes | Yes | Yes | Yes | Yes |
| halogenated alkyl | | | | | | |
| and/or alkylene | | | | | | |
| group | | | | | | |

| | Halogenated solvent | | | | |
|---|---|---|---|---|---|
| | CFS-1 | CFS-2 | CFS-3 | CFS-4 | CFS-5 |
| Halogenation degree (%) | 64.3 | 100 | 100 | 88-90 | 66.7 |
| Partially halogenated | No | No | No | Yes | No |
| alkyl and/or alkylene | | | | | |
| group | | | | | |

### Example A 1-1

### Evaluation of Compatibility of Electrolyte Components

As illustrated in Table A1 below, 0.5 litter (L) each of the ionic liquid TMHA and the halogenated solvent FS-1 were mixed at 25° C. to prepare a solvent composition. The condition of the composition was observed at 25° C. with eye. It was confirmed that the composition was a transparent and uniform liquid as described in Table A1. In other words, it could be understood that in this example, the electrolyte components could be well dissolved in the single phase and uniform condition.

### Examples A1-2 to A1-24

In these examples, the composition of the solvent composition was changed as tabulated in Table A1 although the procedure of Example A1-1 described above was repeated. When the condition of each of the resulting compositions was observed with eye at 25° C., it was observed that the electrolyte components could be well dissolved in the single phase and uniform condition.

### Comparative Examples A 1-1 to A1-3

In these examples, the composition of the solvent composition was changed as tabulated in Table A1 for comparison although the procedure of Example A1-1 described above was repeated. When the condition of the resulting compositions was observed with eye at 25° C., the observation result described in Table A1 could be obtained. Incidentally, the term “non-uniform” means that the separation of the electrolyte components occurred in the resulting solvent composition and the liquid was turbid.

TABLE A1

| | | | | Amount of | Amount of | Amount of | |
|---|---|---|---|---|---|---|---|
| No. of | Ionic | Halogenated | Additional | ionic liquid | halogenated | additional salt | |
| Example | liquid | solvent | salt | (litter) | solvent (litter) | (mole) | Composition at 25° C. |
| Example | TMHA | FS-1 | | 0.5 | 0.5 | 0 | transparent and |
| A1-1 | | | | | | | homogeneous liquid |
| Example | TMHA | FS-1 | LiTFSI | 0.5 | 0.5 | 1 | transparent and |
| A1-2 | | | | | | | homogeneous liquid |
| Example | TMHA | FS-2 | | 0.5 | 0.5 | 0 | transparent and |
| A1-3 | | | | | | | homogeneous liquid |
| Example | TMHA | FS-2 | LiTFSI | 0.5 | 0.5 | 1 | transparent and |
| A1-4 | | | | | | | homogeneous liquid |
| Example | TMHA | FS-3 | | 0.5 | 0.5 | 0 | transparent and |
| A1-5 | | | | | | | homogeneous liquid |
| Example | TMHA | FS-3 | LiTFSI | 0.5 | 0.5 | 1 | transparent and |
| A1-6 | | | | | | | homogeneous liquid |
| Example | TMHA | FS-5 | | 0.5 | 0.5 | 0 | transparent and |
| A1-7 | | | | | | | homogeneous liquid |
| Example | TMHA | FS-5 | LiTFSI | 0.5 | 0.5 | 1 | transparent and |
| A1-8 | | | | | | | homogeneous liquid |
| Example | TMHA | FS-7 | | 0.5 | 0.5 | 0 | transparent and |
| A1-9 | | | | | | | homogeneous liquid |
| Example | TMHA | FS-8 | | 0.5 | 0.5 | 0 | transparent and |
| A1-10 | | | | | | | homogeneous liquid |
| Example | TMHA | FS-8 | LiTFSI | 0.5 | 0.5 | 1 | transparent and |
| A1-11 | | | | | | | homogeneous liquid |
| Example | TMHA | FS-9 | | 0.5 | 0.5 | 0 | transparent and |
| A1-12 | | | | | | | homogeneous liquid |
| Example | TMHA | FS-9 | LiTFSI | 0.5 | 0.5 | 1 | transparent and |
| A1-13 | | | | | | | homogeneous liquid |
| Example | TMHA | FS-10 | | 0.5 | 0.5 | 0 | transparent and |
| A1-14 | | | | | | | homogeneous liquid |
| Example | TMHA | FS-10 | LiTFSI | 0.5 | 0.5 | 1 | transparent and |
| A1-15 | | | | | | | homogeneous liquid |
| Example | TMHA | FS-11 | | 0.5 | 0.5 | 0 | transparent and |
| A1-16 | | | | | | | homogeneous liquid |
| Example | TMHA | FS-11 | LiTFSI | 0.5 | 0.5 | 1 | transparent and |
| A1-17 | | | | | | | homogeneous liquid |
| Example | TMHA | FS-12 | | 0.5 | 0.5 | 0 | transparent and |
| A1-18 | | | | | | | homogeneous liquid |
| Example | TMHA | FS-13 | | 0.5 | 0.5 | 0 | transparent and |
| A1-19 | | | | | | | homogeneous liquid |
| Example | TMHA | FS-13 | LiTFSI | 0.5 | 0.5 | 1 | transparent and |
| A1-20 | | | | | | | homogeneous liquid |
| Example | TMHA | FS-3 | | 0.75 | 0.25 | 0 | transparent and |
| A1-21 | | | | | | | homogeneous liquid |
| Example | TMHA | FS-3 | LiTFSI | 0.75 | 0.25 | 0.5 | transparent and |
| A1-22 | | | | | | | homogeneous liquid |
| Example | TMHA | FS-3 | | 0.25 | 0.75 | 0 | transparent and |
| A1-23 | | | | | | | homogeneous liquid |
| Example | TMHA | FS-3 | LiTFSI | 0.25 | 0.75 | 0.25 | transparent and |
| A1-24 | | | | | | | homogeneous liquid |
| Comp. | TMHA | CFS-1 | | 0.5 | 0.5 | 0 | unhomogeneous |
| Ex. A1-1 | | | | | | | |
| Comp. | TMHA | CFS-3 | | 0.5 | 0.5 | 0 | unhomogeneous |
| Ex. A1-2 | | | | | | | |
| Comp. | TMHA | CFS-4 | | 0.5 | 0.5 | 0 | unhomogeneous |
| Ex. A1-3 | | | | | | | |

### Example A2-1

### Evaluation of Compatibility of Electrolyte Components

As illustrated in Table A2 below, 0.5 litter (L) each of the ionic liquid TMPA and the halogenated solvent FS-1 were mixed at 25° C. to prepare a solvent composition. The condition of the composition was observed at 25° C. and 0° C. with eye. It was confirmed that the composition was a transparent and uniform liquid as described in Table A2. In other words, it could be understood that in this example, the electrolyte component could be well dissolved in the single phase and uniform condition.

### Examples A2-2 to A2-16

In these examples, the composition of the solvent composition was changed as tabulated in Table A2 although the procedure of Example A2-1 described above was repeated. When the condition of each of the resulting compositions was observed with eye at 25° C. and 0° C., it was observed that the electrolyte component could be dissolved in the single phase and uniform condition as described in Table A2.

### Comparative Examples A2-1 to A2-4

In these examples, the composition of the solvent composition was changed as tabulated in Table A2 for comparison although the procedure of Example A2-1 described above was repeated. When the condition of the resulting compositions was observed with eye at 25° C. and 0° C., it was observed that the resulting solvent composition was non-uniform, the separation of the electrolyte component occurred and the liquid was turbid as described in Table A2.

TABLE A2

| | | | | Amount of | Amount of | Amount of | | |
|---|---|---|---|---|---|---|---|---|
| No. of | Ionic | Halogenated | Additional | ionic liquid | halogenated | additional salt | Composition | Composition |
| Example | liquid | solvent | salt | (litter) | solvent (litter) | (mole) | at 25° C. | at 0° C. |
| Example | TMPA | FS-1 | | 0.5 | 0.5 | 0 | transparent and | transparent and |
| A2-1 | | | | | | | homogeneous liquid | homogeneous liquid |
| Example | TMPA | FS-1 | LiTFSI | 0.5 | 0.5 | 0.5 | transparent and | transparent and |
| A2-2 | | | | | | | homogeneous liquid | homogeneous liquid |
| Example | TMPA | FS-2 | | 0.5 | 0.5 | 0 | transparent and | transparent and |
| A2-3 | | | | | | | homogeneous liquid | homogeneous liquid |
| Example | TMPA | FS-3 | | 0.5 | 0.5 | 0 | transparent and | transparent and |
| A2-4 | | | | | | | homogeneous liquid | homogeneous liquid |
| Example | TMPA | FS-3 | LiTFSI | 0.5 | 0.5 | 0.5 | transparent and | transparent and |
| A2-5 | | | | | | | homogeneous liquid | homogeneous liquid |
| Example | TMPA | FS-4 | | 0.5 | 0.5 | 0 | transparent and | transparent and |
| A2-6 | | | | | | | homogeneous liquid | homogeneous liquid |
| Example | TMPA | FS-5 | | 0.5 | 0.5 | 0 | transparent and | transparent and |
| A2-7 | | | | | | | homogeneous liquid | homogeneous liquid |
| Example | TMPA | FS-8 | | 0.5 | 0.5 | 0 | transparent and | transparent and |
| A2-8 | | | | | | | homogeneous liquid | homogeneous liquid |
| Example | TMPA | FS-8 | LiTFSI | 0.5 | 0.5 | 0.5 | transparent and | transparent and |
| A2-9 | | | | | | | homogeneous liquid | homogeneous liquid |
| Example | TMPA | FS-9 | | 0.5 | 0.5 | 0 | transparent and | transparent and |
| A2-10 | | | | | | | homogeneous liquid | homogeneous liquid |
| Example | TMPA | FS-9 | LiTFSI | 0.5 | 0.5 | 0.5 | transparent and | transparent and |
| A2-11 | | | | | | | homogeneous liquid | homogeneous liquid |
| Example | TMPA | FS-10 | | 0.5 | 0.5 | 0 | transparent and | transparent and |
| A2-12 | | | | | | | homogeneous liquid | homogeneous liquid |
| Example | TMPA | FS-10 | LiTFSI | 0.5 | 0.5 | 0.5 | transparent and | transparent and |
| A2-13 | | | | | | | homogeneous liquid | homogeneous liquid |
| Example | TMPA | FS-12 | | 0.5 | 0.5 | 0 | transparent and | transparent and |
| A2-14 | | | | | | | homogeneous liquid | homogeneous liquid |
| Example | TMPA | FS-13 | | 0.5 | 0.5 | 0 | transparent and | transparent and |
| A2-15 | | | | | | | homogeneous liquid | homogeneous liquid |
| Example | TMPA | FS-13 | LiTFSI | 0.5 | 0.5 | 0.5 | transparent and | transparent and |
| A2-16 | | | | | | | homogeneous liquid | homogeneous liquid |
| Comp. | TMPA | CFS-1 | | 0.5 | 0.5 | 0 | unhomogeneous | unhomogeneous |
| Ex. A2-1 | | | | | | | | |
| Comp. | TMPA | CFS-2 | | 0.5 | 0.5 | 0 | unhomogeneous | unhomogeneous |
| Ex. A2-2 | | | | | | | | |
| Comp. | TMPA | CFS-4 | | 0.5 | 0.5 | 0 | unhomogeneous | unhomogeneous |
| Ex. A2-3 | | | | | | | | |
| Comp. | TMPA | CFS-5 | | 0.5 | 0.5 | 0 | unhomogeneous | unhomogeneous |
| Ex. A2-4 | | | | | | | | |

### Example A3-1

### Evaluation of Compatibility of Electrolyte Components

As illustrated in Table A3 below, 0.5 litter (L) each of the ionic liquid PP13 and the halogenated solvent FS-1 were mixed at 25° C. to prepare a solvent composition. The condition of the composition was observed at 25° C. and 0° C. with eye. It was confirmed that the composition was a transparent and uniform liquid as described in Table A3. In other words, it could be understood that in this example, the electrolyte component could be well dissolved in the single phase and uniform condition.

### Examples A3-2 to A3-22

In these examples, the composition of the solvent composition was changed as tabulated in Table A3 although the procedure of Example A3-1 described above was repeated. When the condition of each of the resulting compositions was observed with eye at 25° C. and 0° C., it was observed that the electrolyte component could be well dissolved in the single phase and uniform condition as described in Table A3.

### Comparative Examples A3-1 to A3-4

In these examples, the composition of the solvent composition was changed as tabulated in Table A3 for comparison although the procedure of Example A3-1 described above was repeated. When the condition of the resulting compositions was observed with eye at 25° C. and 0° C., it was observed that the resulting solvent composition was non-uniform, the separation of the electrolyte component occurred and the liquid was turbid as described in Table A3.

TABLE A3

| | | | | Amount of | Amount of | Amount of | | |
|---|---|---|---|---|---|---|---|---|
| No. of | Ionic | Halogenated | Additional | ionic liquid | halogenated | additional salt | Composition | Composition |
| Example | liquid | solvent | salt | (litter) | solvent (litter) | (mole) | at 25° C. | at 0° C. |
| Example | PP13 | FS-1 | | 0.5 | 0.5 | 0 | transparent and | transparent and |
| A3-1 | | | | | | | homogeneous liquid | homogeneous liquid |
| Example | PP13 | FS-1 | LiTFSI | 0.5 | 0.5 | 0.5 | transparent and | transparent and |
| A3-2 | | | | | | | homogeneous liquid | homogeneous liquid |
| Example | PP13 | FS-2 | | 0.5 | 0.5 | 0 | transparent and | transparent and |
| A3-3 | | | | | | | homogeneous liquid | homogeneous liquid |
| Example | PP13 | FS-2 | LiTFSI | 0.5 | 0.5 | 0.5 | transparent and | transparent and |
| A3-4 | | | | | | | homogeneous liquid | homogeneous liquid |
| Example | PP13 | FS-3 | | 0.5 | 0.5 | 0 | transparent and | transparent and |
| A3-5 | | | | | | | homogeneous liquid | homogeneous liquid |
| Example | PP13 | FS-3 | LiTFSI | 0.5 | 0.5 | 0.5 | transparent and | transparent and |
| A3-6 | | | | | | | homogeneous liquid | homogeneous liquid |
| Example | PP13 | FS-4 | | 0.5 | 0.5 | 0 | transparent and | transparent and |
| A3-7 | | | | | | | homogeneous liquid | homogeneous liquid |
| Example | PP13 | FS-4 | LiTFSI | 0.5 | 0.5 | 0.5 | transparent and | transparent and |
| A3-8 | | | | | | | homogeneous liquid | homogeneous liquid |
| Example | PP13 | FS-5 | | 0.5 | 0.5 | 0 | transparent and | transparent and |
| A3-9 | | | | | | | homogeneous liquid | homogeneous liquid |
| Example | PP13 | FS-5 | LiTFSI | 0.5 | 0.5 | 0.5 | transparent and | transparent and |
| A3-10 | | | | | | | homogeneous liquid | homogeneous liquid |
| Example | PP13 | FS-6 | | 0.5 | 0.5 | 0 | transparent and | transparent and |
| A3-11 | | | | | | | homogeneous liquid | homogeneous liquid |
| Example | PP13 | FS-7 | | 0.5 | 0.5 | 0 | transparent and | transparent and |
| A3-12 | | | | | | | homogeneous liquid | homogeneous liquid |
| Example | PP13 | FS-8 | | 0.5 | 0.5 | 0 | transparent and | transparent and |
| A3-13 | | | | | | | homogeneous liquid | homogeneous liquid |
| Example | PP13 | FS-8 | LiTFSI | 0.5 | 0.5 | 0.5 | transparent and | transparent and |
| A3-14 | | | | | | | homogeneous liquid | homogeneous liquid |
| Example | PP13 | FS-9 | | 0.5 | 0.5 | 0 | transparent and | transparent and |
| A3-15 | | | | | | | homogeneous liquid | homogeneous liquid |
| Example | PP13 | FS-9 | LiTFSI | 0.5 | 0.5 | 0.5 | transparent and | transparent and |
| A3-16 | | | | | | | homogeneous liquid | homogeneous liquid |
| Example | PP13 | FS-10 | | 0.5 | 0.5 | 0 | transparent and | transparent and |
| A3-17 | | | | | | | homogeneous liquid | homogeneous liquid |
| Example | PP13 | FS-10 | LiTFSI | 0.5 | 0.5 | 0.5 | transparent and | transparent and |
| A3-18 | | | | | | | homogeneous liquid | homogeneous liquid |
| Example | PP13 | FS-12 | | 0.5 | 0.5 | 0 | transparent and | transparent and |
| A3-19 | | | | | | | homogeneous liquid | homogeneous liquid |
| Example | PP13 | FS-12 | LiTFSI | 0.5 | 0.5 | 0.5 | transparent and | transparent and |
| A3-20 | | | | | | | homogeneous liquid | homogeneous liquid |
| Example | PP13 | FS-13 | | 0.5 | 0.5 | 0 | transparent and | transparent and |
| A3-21 | | | | | | | homogeneous liquid | homogeneous liquid |
| Example | PP13 | FS-13 | LiTFSI | 0.5 | 0.5 | 0.5 | transparent and | transparent and |
| A3-22 | | | | | | | homogeneous liquid | homogeneous liquid |
| Comp. | PP13 | CFS-1 | | 0.5 | 0.5 | 0 | unhomogeneous | unhomogeneous |
| Ex. A3-1 | | | | | | | | |
| Comp. | PP13 | CFS-2 | | 0.5 | 0.5 | 0 | unhomogeneous | unhomogeneous |
| Ex. A3-2 | | | | | | | | |
| Comp. | PP13 | CFS-4 | | 0.5 | 0.5 | 0 | unhomogeneous | unhomogeneous |
| Ex. A3-3 | | | | | | | | |
| Comp. | PP13 | CFS-5 | | 0.5 | 0.5 | 0 | unhomogeneous | unhomogeneous |
| Ex. A3-4 | | | | | | | | |

### Example A4-1

### Evaluation of Compatibility of Electrolyte Components

As illustrated in Table A4 below, 0.5 litter (L) each of the ionic liquid DEME and the halogenated solvent FS-1 were mixed at 25° C. to prepare a solvent composition. The condition of the composition was observed at 25° C. and 0° C. with eye. It was confirmed that the composition was a transparent and uniform liquid as described in Table A4. In other words, it could be understood that in this example, the electrolyte component could be well dissolved in the single phase and uniform condition.

### Examples A4-2 to A4-23

In these examples, the composition of the solvent composition was changed as tabulated in Table A4 although the procedure of Example A4-1 described above was repeated. When the condition of each of the resulting compositions was observed with eye at 25° C. and 0° C., it was observed that the electrolyte component could be well dissolved in the single phase and uniform condition as described in Table A4.

TABLE A4

| | | | | Amount of | Amount | Amount of | | |
|---|---|---|---|---|---|---|---|---|
| No. of | Ionic | Halogenated | Additional | ionic liquid | of halogenated | additional salt | | |
| Example | liquid | solvent | salt | (litter) | solvent (litter) | (mole) | Composition at 25° C. | Composition at 0° C. |
| Example | DEME | FS-1 | | 0.5 | 0.5 | 0 | transparent and | transparent and |
| A4-1 | | | | | | | homogeneous liquid | homogeneous liquid |
| Example | DEME | FS-1 | LiTFSI | 0.5 | 0.5 | 0.5 | transparent and | transparent and |
| A4-2 | | | | | | | homogeneous liquid | homogeneous liquid |
| Example | DEME | FS-2 | | 0.5 | 0.5 | 0 | transparent and | transparent and |
| A4-3 | | | | | | | homogeneous liquid | homogeneous liquid |
| Example | DEME | FS-3 | | 0.5 | 0.5 | 0 | transparent and | transparent and |
| A4-4 | | | | | | | homogeneous liquid | homogeneous liquid |
| Example | DEME | FS-3 | LiTFSI | 0.5 | 0.5 | 0.5 | transparent and | transparent and |
| A4-5 | | | | | | | homogeneous liquid | homogeneous liquid |
| Example | DEME | FS-3 | | 0.75 | 0.25 | 0 | transparent and | transparent and |
| A4-6 | | | | | | | homogeneous liquid | homogeneous liquid |
| Example | DEME | FS-3 | LiTFSI | 0.75 | 0.25 | 0.5 | transparent and | transparent and |
| A4-7 | | | | | | | homogeneous liquid | homogeneous liquid |
| Example | DEME | FS-4 | | 0.5 | 0.5 | 0 | transparent and | transparent and |
| A4-8 | | | | | | | homogeneous liquid | homogeneous liquid |
| Example | DEME | FS-9 | | 0.5 | 0.5 | 0 | transparent and | transparent and |
| A4-9 | | | | | | | homogeneous liquid | homogeneous liquid |
| Example | DEME | FS-10 | | 0.5 | 0.5 | 0 | transparent and | transparent and |
| A4-10 | | | | | | | homogeneous liquid | homogeneous liquid |
| Example | DEME | FS-12 | | 0.5 | 0.5 | 0 | transparent and | transparent and |
| A4-11 | | | | | | | homogeneous liquid | homogeneous liquid |
| Example | DEME | FS-13 | | 0.5 | 0.5 | 0 | transparent and | transparent and |
| A4-12 | | | | | | | homogeneous liquid | homogeneous liquid |
| Example | DEMEB | FS-1 | | 0.5 | 0.5 | 0 | transparent and | transparent and |
| A4-13 | | | | | | | homogeneous liquid | homogeneous liquid |
| Example | DEMEB | FS-3 | | 0.5 | 0.5 | 0 | transparent and | transparent and |
| A4-14 | | | | | | | homogeneous liquid | homogeneous liquid |
| Example | DEMEB | FS-4 | | 0.5 | 0.5 | 0 | transparent and | transparent and |
| A4-15 | | | | | | | homogeneous liquid | homogeneous liquid |
| Example | DEMEB | FS-9 | | 0.5 | 0.5 | 0 | transparent and | transparent and |
| A4-16 | | | | | | | homogeneous liquid | homogeneous liquid |
| Example | DEMEB | FS-10 | | 0.5 | 0.5 | 0 | transparent and | transparent and |
| A4-17 | | | | | | | homogeneous liquid | homogeneous liquid |
| Example | DEMEB | FS-12 | | 0.5 | 0.5 | 0 | transparent and | transparent and |
| A4-18 | | | | | | | homogeneous liquid | homogeneous liquid |
| Example | DEMEB | FS-13 | | 0.5 | 0.5 | 0 | transparent and | transparent and |
| A4-19 | | | | | | | homogeneous liquid | homogeneous liquid |
| Example | EMIB | FS-1 | | 0.5 | 0.5 | 0 | transparent and | transparent and |
| A4-20 | | | | | | | homogeneous liquid | homogeneous liquid |
| Example | EMIB | FS-9 | | 0.5 | 0.5 | 0 | transparent and | transparent and |
| A4-21 | | | | | | | homogeneous liquid | homogeneous liquid |
| Example | EMIB | FS-10 | | 0.5 | 0.5 | 0 | transparent and | transparent and |
| A4-22 | | | | | | | homogeneous liquid | homogeneous liquid |
| Example | EMIB | FS-13 | | 0.5 | 0.5 | 0 | transparent and | transparent and |
| A4-23 | | | | | | | homogeneous liquid | homogeneous liquid |

### Examples B-1-1 and B1-2 and Comparative Example B1-1

### Evaluation of Ion Conductivity of Non-Aqueous Electrolyte

### Example B1-1

As illustrated in Table B1 below, 0.75 L of an ionic liquid TMHA and 0.25 L of a halogenated solvent FS-3 were mixed at 25° C. to prepare a solvent composition. Ion conductivity of the resulting solvent composition was measured at 20° C. In the determination of the ion conductivity, “Conductivity Meter D-24” (trade name) commercially available from Horiba Sensakusho was used. As described in Table BI, the ion conductivity of this example was 102 (mS/m) and was sufficiently satisfactory when used as a non-aqueous electrolyte for a lithium type cell.

### Example B1-2

In this example, the composition of the solvent composition was changed as tabulated in Table B1 although the procedure of Example B1-1 described above was repeated. When the ion conductivity of the resulting composition at 20° C. was measured, it was 106 (mS/m) and was comparable to the ion conductivity of Example B1-1.

### Comparative Example B1-1

In this comparative example, the addition of the halogenated solvent was omitted as tabulated in Table B1 below although the procedure of Example B1-1 described above was repeated. When the ion conductivity of the resulting composition at 20° C. was measured, it was 87 (mS/m) and its drop was confirmed in comparison with the ion conductivity of Example B1-1.

### Examples B1-3 and B1-4 and Comparative Example B1-2

Although the procedure of Examples B1-1 and B1-2 and Comparative Example B1-1 was repeated, the measurement temperature was changed from 20° C. to 0° C. in these cases as tabulated in Table B1 below. The measurement results shown in Table B1 were obtained for each example. It could be understood from these measurement results that the ion conductivity that was remarkably improved in comparison with the comparative example could be obtained in each example although the measurement temperature was lowered.

### Examples B1-5 and B1-6 and Comparative Example B1-3

Although the procedure of Examples B1-1 and B1-2 and Comparative Example B1-1 was repeated, the composition of the solvent composition was changed in these cases by further adding LiTFSI as tabulated in Table B1 below. When the ion conductivity at 20° C. of each of the resulting compositions was measured, the results tabulated in Table B1 could be obtained. It could be understood from these measurement results that the ion conductivity that was remarkably improved in comparison with the comparative example could be obtained in each example.

### Examples B1-7 and B1-8 and Comparative Example B1-4

Although the procedure of Examples B1-5 and B1-6 and Comparative Example B1-3 was repeated, the measurement temperature was changed from 20° C. to 0° C. in these cases as tabulated in Table B1 below. The measurement results shown in Table B1 were obtained for each example. It could be understood from these measurement results that the ion conductivity that was remarkably improved in comparison with the comparative example could be obtained in each example although the measurement temperature was lowered.

### Examples B1-9 and B1-10 and Comparative Example B1-5

Although the procedure of Examples B1-1 and B1-2 and Comparative Example B1-1 was repeated, the composition of the solvent composition was changed in these cases by further adding LiTFSI as tabulated in Table B1 below. When the ion conductivity at 20° C. of each of the resulting compositions was measured, the results tabulated in Table B1 could be obtained. It could be understood from these measurement results that the ion conductivity that was remarkably improved in comparison with the comparative example could be obtained in each example.

### Examples B 1-11 and B1-12 and Comparative Example B1-6

Although the procedure of Examples B1-9 and B1-10 and Comparative Example B1-5 was repeated, the measurement temperature was changed from 20° C. to 0° C. in these cases as tabulated in Table B1 below. The measurement results shown in Table B1 were obtained for each example. It could be understood from these measurement results that the ion conductivity that was remarkably improved in comparison with the comparative example could be obtained in each example although the measurement temperature was lowered.

TABLE B1

| | | | | Amount of | Amount of | Amount of | | Ionic |
|---|---|---|---|---|---|---|---|---|
| No. of | Ionic | Halogenated | Additional | ionic liquid | halogenated | additional salt | Temperature | conductivity |
| Example | liquid | solvent | salt | (litter) | solvent (litter) | (mole) | (° C.) | (mS/m) |
| Example | TMHA | FS-3 | | 0.75 | 0.25 | 0 | 20 | 102 |
| B1-1 | | | | | | | | |
| Example | TMHA | FS-3 | | 0.5 | 0.5 | 0 | 20 | 106 |
| B1-2 | | | | | | | | |
| Comp. | TMHA | FS-3 | | 1 | 0 | 0 | 20 | 87 |
| Ex. B1-1 | | | | | | | | |
| Example | TMHA | FS-3 | | 0.75 | 0.25 | 0 | 0 | 35 |
| B1-3 | | | | | | | | |
| Example | TMHA | FS-3 | | 0.5 | 0.5 | 0 | 0 | 44 |
| B1-4 | | | | | | | | |
| Comp. | TMHA | FS-3 | | 1 | 0 | 0 | 0 | 25 |
| Ex. B1-2 | | | | | | | | |
| Example | TMHA | FS-3 | LiTFSI | 0.75 | 0.25 | 0.25 | 20 | 73 |
| B1-5 | | | | | | | | |
| Example | TMHA | FS-3 | LiTFSI | 0.5 | 0.5 | 0.25 | 20 | 87 |
| B1-6 | | | | | | | | |
| Comp. | TMHA | FS-3 | LiTFSI | 1 | 0 | 0.25 | 20 | 59 |
| Ex. B1-3 | | | | | | | | |
| Example | TMHA | FS-3 | LiTFSI | 0.75 | 0.25 | 0.25 | 0 | 23 |
| B1-7 | | | | | | | | |
| Example | TMHA | FS-3 | LiTFSI | 0.5 | 0.5 | 0.25 | 0 | 34 |
| B1-8 | | | | | | | | |
| Comp. | TMHA | FS-3 | LiTFSI | 1 | 0 | 0.25 | 0 | 14 |
| Ex. B1-4 | | | | | | | | |
| Example | TMHA | FS-3 | LiTFSI | 0.75 | 0.25 | 0.5 | 20 | 52 |
| B1-9 | | | | | | | | |
| Example | TMHA | FS-3 | LiTFSI | 0.5 | 0.5 | 0.5 | 20 | 55 |
| B1-10 | | | | | | | | |
| Comp. | TMHA | FS-3 | LiTFSI | 1 | 0 | 0.5 | 20 | 39 |
| Ex. B1-5 | | | | | | | | |
| Example | TMHA | FS-3 | LiTFSI | 0.75 | 0.25 | 0.5 | 0 | 15 |
| B1-11 | | | | | | | | |
| Example | TMHA | FS-3 | LiTFSI | 0.5 | 0.5 | 0.5 | 0 | 20 |
| B1-12 | | | | | | | | |
| Comp. | TMHA | FS-3 | LiTFSI | 1 | 0 | 0.5 | 0 | 8 |
| Ex. B1-6 | | | | | | | | |

### Examples B2-1 and Comparative Example B2-1

### Evaluation of Ion Conductivity of Non-Aqueous Electrolyte

### Example B2-1

As illustrated in Table B2 below, 0.75 L of an ionic liquid DEME and 0.25 L of a halogenated solvent FS-3 were mixed to prepare a solvent composition and ion conductivity was measured at 20° C. As described in Table B2, the ion conductivity of this example was 209 (mS/m) and was sufficiently satisfactory when used as a non-aqueous electrolyte for a lithium type cell.

### Comparative Example B2-1

In this comparative example, the addition of the halogenated solvent was omitted as tabulated in Table B2 below although the procedure of Example B2-1 described above was repeated. When the ion conductivity of the resulting composition at 20° C. was measured, it was 204 (mS/m) and was confirmed to be inferior to the ion conductivity of Example B2-1.

### Example B2-2 and Comparative Example B2-2

Although the procedure of Example B2-1 and Comparative Example B2-1 was repeated, the measurement temperature was changed from 20° C. to 0° C. in these cases as tabulated in Table B2 below. The measurement results shown in Table B2 were obtained for each example. It could be understood from these measurement results that excellent ion conductivity in comparison with Comparative Example B2-2 could be obtained in Example B2-2 although the measurement temperature was lowered.

### Example B2-3 and Comparative Example B2-3

Although the procedure of Example B2-1 and Comparative Example B2-1 was repeated, the composition of the solvent composition was changed in these cases by further adding LiTFSI as tabulated in Table B2 below. When the ion conductivity at 20° C. of each of the resulting compositions was measured, the results tabulated in Table B2 could be obtained. It could be understood from these measurement results that excellent ion conductivity in comparison with Comparative Example B2-3 could be obtained in Example B2-3.

### Example B2-4 and Comparative Example B2-4

Although the procedure of Example B2-3 and Comparative Example B2-3 was repeated, the measurement temperature was changed from 20° C. to 0° C. in these cases as tabulated in Table B2 below. The measurement results shown in Table B2 were obtained for each example. It could be understood from these measurement results that excellent ion conductivity in comparison with Comparative Example B2-4 could be obtained in Example B2-4 although the measurement temperature was lowered.

### Example B2-5 and Comparative Example B2-5

Although the procedure of Example B2-1 and Comparative Example B2-1 was repeated, the composition of the solvent composition was changed in these cases by further adding LiTFSI as tabulated in Table B2 below. When the ion conductivity at 20° C. of each of the resulting compositions was measured, the results tabulated in Table B2 could be obtained. It could be understood from these measurement results that excellent ion conductivity in comparison with Comparative Example B2-5 could be obtained in Example B2-5.

### Example B2-6 and Comparative Example B2-6

Although the procedure of Example B2-5 and Comparative Example B2-5 was repeated, the measurement temperature was changed from 20° C. to 0° C. in these cases as tabulated in Table B2 below. The measurement results shown in Table B2 were obtained for each example. It could be understood from these measurement results that excellent ion conductivity in comparison with Comparative Example B2-6 could be obtained in Example B2-6 although the measurement temperature was lowered.

TABLE B2

| | | | | Amount of | Amount of | Amount of | | Ionic |
|---|---|---|---|---|---|---|---|---|
| No. of | Ionic | Halogenated | Additional | ionic liquid | halogenated | additional salt | Temperature | conductivity |
| Example | liquid | solvent | salt | (litter) | solvent (litter) | (mole) | (° C.) | (mS/m) |
| Example | DEME | FS-3 | | 0.75 | 0.25 | 0 | 20 | 209 |
| B2-1 | | | | | | | | |
| Comp. | DEME | FS-3 | | 1 | 0 | 0 | 20 | 204 |
| Ex. B2-1 | | | | | | | | |
| Example | DEME | FS-3 | | 0.75 | 0.25 | 0 | 0 | 77 |
| B2-2 | | | | | | | | |
| Comp. | DEME | FS-3 | | 1 | 0 | 0 | 0 | 66 |
| Ex. B2-2 | | | | | | | | |
| Example | DEME | FS-3 | LiTFSI | 0.75 | 0.25 | 0.25 | 20 | 152 |
| B2-3 | | | | | | | | |
| Comp. | DEME | FS-3 | LiTFSI | 1 | 0 | 0.25 | 20 | 146 |
| Ex. B2-3 | | | | | | | | |
| Example | DEME | FS-3 | LiTFSI | 0.75 | 0.25 | 0.25 | 0 | 52 |
| B2-4 | | | | | | | | |
| Comp. | DEME | FS-3 | LiTFSI | 1 | 0 | 0.25 | 0 | 44 |
| Ex. B2-4 | | | | | | | | |
| Example | DEME | FS-3 | LiTFSI | 0.75 | 0.25 | 0.5 | 20 | 114 |
| B2-5 | | | | | | | | |
| Comp. | DEME | FS-3 | LiTFSI | 1 | 0 | 0.5 | 20 | 109 |
| Ex. B2-5 | | | | | | | | |
| Example | DEME | FS-3 | LiTFSI | 0.75 | 0.25 | 0.5 | 0 | 35 |
| B2-6 | | | | | | | | |
| Comp. | DEME | FS-3 | LiTFSI | 1 | 0 | 0.5 | 0 | 29 |
| Ex. B2-6 | | | | | | | | |

### Example C1

### Production of Coin Type Lithium Ion Cell

To produce a positive electrode, a slurry liquid consisting of lithium cobalt oxide (LiCoO₂: active material), acetylene black (conduction assistant), polyvinylidene fluoride (binder) and N-methyl-2-pyrrolidone (solvent) was prepared. In this example, the slurry liquid was prepared so that the electrode composition after drying consisted of 90% of the active material, 5% of the conduction assistant and 5% of the binder. Next, the resulting slurry liquid was applied to one of the surfaces of a 25 μm-thick aluminum foil and was further dried. A disk having a diameter of 15.96 mm and an area of one surface of 2.00 cm² was punched out from the aluminum foil and was used as the positive electrode. Furthermore, to use as a non-aqueous electrolyte, 0.5 mol of LiTFSI (lithium support electrolyte) was further added to a mixture of 0.5 L of DEME (ionic liquid) and 0.5 L of FS-1 (halogenated solvent) to prepare a transparent and uniform liquid. The non-aqueous electrolyte and a glass filter (separator) were sandwiched between the coating surface of the positive electrode and the negative electrode. There was thus obtained a coin type lithium ion cell having a construction similar to the construction schematically shown in FIG. 1.

### Cycle Test of Cells:

Charge/discharge was conducted in the following procedure in the coin type cell to evaluate the charge/discharge characteristics. First, charging was conducted at a constant current corresponding to 0.1 C with respect to a theoretical capacity (CmAh) calculated from the weight of lithium cobalt oxide used for the positive electrode and was completed when the cell voltage reached 4.2 V (in the mean time, lithium ion dissociation from the active material was made), followed by a break for 10 minutes. Next, discharging was made at a constant current corresponding to 0.1 C and was completed when the cell voltage reached 2.5 V (in the mean time, lithium ion insertion into the active material was made), followed then by a break for 10 minutes. The operation described above (lithium ion dissociation/insertion process) constituted one cycle and the same operation was carried out in 10 cycles. All the operations were carried out at 25° C. in the first charge/discharge cycle and the subsequent charge/discharge cycles.

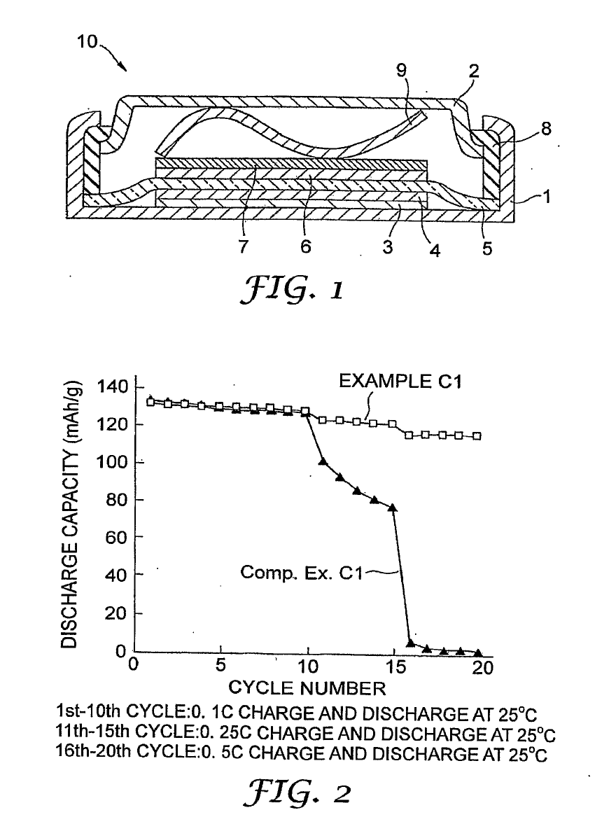

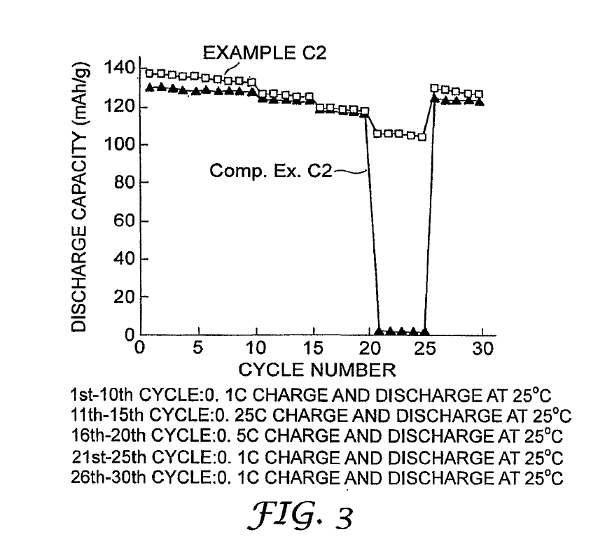

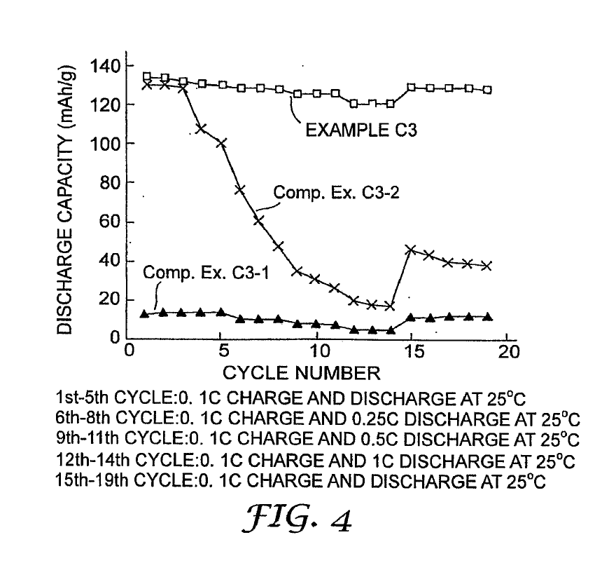

After the first charge/discharge cycle was completed, the first charge/discharge cycle was repeated 5 cycles with the exception that the charge/discharge current value was changed to 0.25 C equivalent (second charge/discharge cycle). Subsequently, the second charge/discharge cycle was repeated 5 cycles with the exception that the charge/discharge current value was changed from 0.25 C equivalent to 0.5 C equivalent (third charge/discharge cycle). In this way, 20 cycles of charge/discharge cycles in total were conducted and the discharge capacity in each cycle was calculated with the result plotted in the graph shown in FIG. 2. In FIG. 2, the discharge capacity plotted on the ordinate was common to FIGS. 3 to 7 and was the value obtained by dividing the discharge capacity of the cell by the weight of lithium cobalt oxide used for the cell (unit: mAh/g). It could be understood from the relation between the number of cycles and the discharge capacity shown in the drawing that the secondary cell using the solvent composition of the invention for the non-aqueous electrolyte was excellent in the high rate charge/discharge characteristics.

### Comparative Example C1

In this comparative example, a mixture of 1.0 L of DEME (ionic liquid) and 0.5 mole of FS-1 (lithium support electrolyte) was used as a non-aqueous electrolyte for comparison although the procedure of Example C1 described above was repeated. There was obtained a graph plotted in FIG. 2 upon measurement of the discharge capacity for each cycle. It could be understood from the relation between the number of cycles and the discharge capacity that the charge/discharge characteristics drastically dropped from intermediate cycles because the secondary cell using the solvent composition of the invention as the non-aqueous electrolyte did not contain the halogenated solvent.

### Example C2

The procedure of Example C1 described above was repeated. In this example, however, the non-aqueous electrolyte was prepared by further adding 0.5 mol of LiTFSI to a mixture of 0.45 L of DEME, 0.5 L of FS-1 and 0.05 L of EC (ethyl carbonate). Furthermore, in charge/discharge of the cell, 5 cycles of 1 C constant current charge/discharge cycle and 5 cycles of 0.1 C constant current charge/discharge cycle were further added to the cell charge/discharge of 30 cycles in total. When the discharge capacity in each cycle was determined, a graph plotted in FIG. 3 was obtained. It could be understood from the relation between the number of cycles and the discharge capacity that the secondary cell using the solvent composition of the invention as the non-aqueous electrolyte was excellent in the high rate charge/discharge characteristics.

### Comparative Example C2

Though the procedure of Example C2 described above was repeated, the non-aqueous electrolyte was prepared from 0.95 L of DEME, 0.05 L of EC and 0.5 mole of LiTSI in this comparative example for comparison. When the discharge capacity in each cycle was calculated, there was obtained a graph plotted in FIG. 3. It could be understood from the relation between the number of cycles and the discharge capacity that the charge/discharge characteristics drastically dropped from the 21^{st} to 25^{th} cycles because the secondary cell using the solvent composition of the invention as the non-aqueous electrolyte did not contain the halogenated solvent and recovered in 26^{th} to 30^{th} cycles.

### Example C3

### Production of Coin Type Lithium Ion Cell

The procedure of Example C1 described above was repeated. In this example, however, the non-aqueous electrolyte was prepared by further adding 0.5 mol of LiTFSI to a mixture of 0.45 L of TMPA (ionic liquid), 0.45 L of FS-2 (halogenated solvent) and 0.1 L of VC (vinylene carbonate). A coin type lithium ion cell having a construction similar to the construction schematically shown in FIG. 1 could be obtained.

### Cycle Test of Cells:

The procedure described in Example C1 was repeated. In this example, however, charging was conducted at a constant current corresponding to 0.1 C with respect to the theoretical capacity (CmAh) calculated from the weight of lithium cobalt oxide used for the positive electrode. Charging was completed when the cell voltage reached 4.2 V and a break was given for 10 minutes. Next, discharging was conducted at a constant current corresponding to 0.1 C and was completed when the cell voltage reached 3.0 V, followed then by a break for 10 minutes. The operations described above constituted one cycle and were repeated in 5 cycles. Subsequently, charging/discharging cycles of 19 cycles in total were conducted in the same way in 3 cycles by changing the discharge current value from 0.1 C equivalent to 0.25 C equivalent, 5 cycles by changing to 0.5 C equivalent, 3 cycles by changing to 1 C equivalent and 5 cycles by changing to 0.1 C. When the discharge capacity in each cycle was determined, a graph plotted in FIG. 4 could be obtained. It could be understood from the relation between the number of cycles and the discharge capacity that the secondary cell using the solvent composition of the invention for the non-aqueous electrolyte was excellent in the high rate charge/discharge characteristics.

### Comparative Example C3-1

The procedure of Example C3 described above was repeated. In this example, however, the non-aqueous electrolyte was prepared from 1 L of TMPA and 0.5 mol of LiTFSI. When the discharge capacity in each cycle was determined, a graph plotted in FIG. 4 was obtained. It could be understood from the relation between the number of cycles and the discharge capacity that the secondary cell using the solvent composition of the invention as the non-aqueous electrolyte was always inferior in the charge/discharge characteristics.

### Comparative Example C3-2

The procedure of Example C3 described above was repeated. In this example, however, the non-aqueous electrolyte was prepared by further adding 0.5 mol of LiTFSI to a mixture of 0.9 L of TMPA and 0.1 L of VC. When the discharge capacity in each cycle was determined, a graph plotted in FIG. 4 was obtained. It could be understood from the relation between the number of cycles and the discharge capacity shown in the drawing that the charge/discharge characteristics abruptly dropped from the 4^{th} cycle in the secondary cell using the solvent composition of the invention as the non-aqueous electrolyte and did not recover to the initial level.

### Example C4

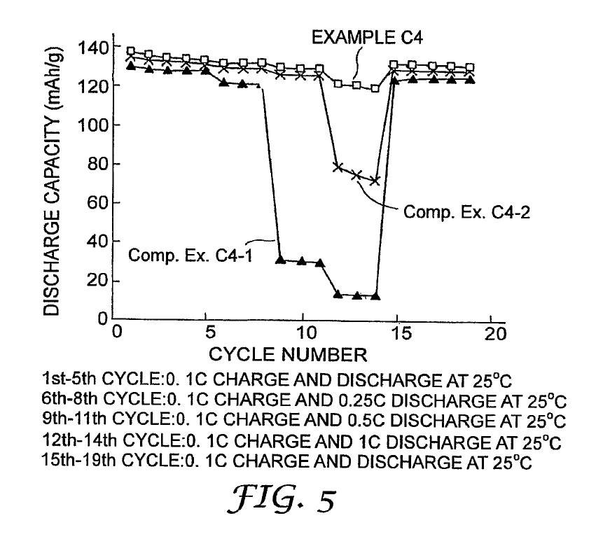

The procedure of Example C3 described above was repeated. In this example, however, the non-aqueous electrolyte was prepared by further adding 0.5 mol of LiTFSI to a mixture of 0.45 L of DEME (ionic liquid), 0.45 L of FS-1 (halogenated solvent) and 0.1 L of VC (vinyl carbonate). When the discharge capacity in each cycle was determined, a graph plotted in FIG. 5 was obtained. It could be understood from the relation between the number of cycles and the discharge capacity shown in the drawing that the secondary cell using the solvent composition of the invention as the non-aqueous electrolyte was excellent in the high rate charge/discharge characteristics.

### Comparative Example C4-1

The procedure of Example C4 described above was repeated. In this example, however, the non-aqueous electrolyte was prepared from 1 L of DEME and 0.5 mol of LiTFSI. When the discharge capacity in each cycle was determined, a graph plotted in FIG. 5 was obtained. It could be understood from the relation between the number of cycles and the discharge capacity shown in the drawing that the secondary cell using the solvent composition of the invention as the non-aqueous electrolyte exhibited the drop of the charge/discharge characteristics in the number of cycles of 9 to 14 but recovered in the number of cycles of 15 to 19.

### Comparative Example C4-2

The procedure of Example C4 described above was repeated. In this example, however, the non-aqueous electrolyte was prepared by further adding 0.5 mol of LiTFSI to a mixture of 0.9 L of DEME and 0.1 L of VC. When the discharge capacity in each cycle was determined, a graph plotted in FIG. 5 was obtained. It could be understood from the relation between the number of cycles and the discharge capacity shown in the drawing that the secondary cell using the solvent composition of the invention as the non-aqueous electrolyte exhibited the drop of the charge/discharge characteristics in the number of cycles of 12 to 14 but recovered in the number of cycles of 15 to 19.

### Example C5

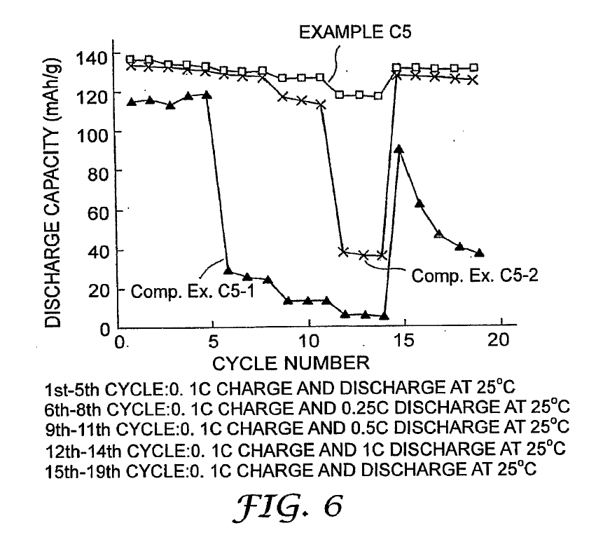

The procedure of Example C3 described above was repeated. In this example, however, the non-aqueous electrolyte was prepared by further adding 0.5 mol of LiTFSI to a mixture of 0.45 L of PP13 (ionic liquid), 0.45 L of FS-3 (halogenated solvent) and 0.1 L of VC (vinyl carbonate). When the discharge capacity in each cycle was determined, a graph plotted in FIG. 6 was obtained. It could be understood from the relation between the number of cycles and the discharge capacity that the secondary cell using the solvent composition of the invention as the non-aqueous electrolyte was excellent in the high rate charge/discharge characteristics.

### Comparative Example C5-1

The procedure of Example C5 described above was repeated. In this example, however, the non-aqueous electrolyte was prepared for comparison from 1 L of PP13 and 0.5 mol of LiTFSI. When the discharge capacity in each cycle was determined, a graph plotted in FIG. 6 was obtained. It could be understood from the relation between the number of cycles and the discharge capacity shown in the drawing that the secondary cell using the solvent composition of the invention as the non-aqueous electrolyte exhibited a drastic drop of the charge/discharge characteristics in the 6^{th} cycle and this drop proceeded to the 14^{th} cycle.

### Comparative Example C5-2

The procedure of Example C5 described above was repeated. In this example, however, the non-aqueous electrolyte was prepared by further adding 0.5 mol LiTFSI to a mixture of 0.9 L of PP13 and 0.1 L of VC. When the discharge capacity in each cycle was determined, a graph plotted in FIG. 6 was obtained. It could be understood from the relation between the number of cycles and the discharge capacity shown in the drawing that the secondary cell using the solvent composition of the invention as the non-aqueous electrolyte exhibited a drastic drop of the charge/discharge characteristics in the 12^{th} cycle and this drop recovered in the 15^{th} to 19^{th} cycle.

When a synthetic observation was made from the measurement results of the discharge capacities plotted in FIGS. 4 to 6, it was found that the secondary cells using the solvent composition of the invention as the non-aqueous electrolyte were excellent in the high rate charge/discharge characteristics. In all of Examples C3, C4 and C5, the discharge capacity of substantially the same level could be obtained in the first 0.1 C charge/discharge (1^{st} to 5^{th} cycles) and the last 0.1 C charge/discharge (15^{th} to 19^{th} cycles). Otherwise, a reasonable discharge capacity could be obtained when minute capacity degradation (gradient of plot) with the cycle was taken into consideration. In the comparative examples corresponding to these examples, however, the discharge capacity could hardly be obtained from the initial stage or got greatly deteriorated in the last 0.1 C charge/discharge (15^{th} to 19^{th} cycles) in some cases. It could be understood that the secondary cells using the compositions of the invention as the non-aqueous electrolyte were excellent in the cycle characteristics, too.

### Example C6

This example was continuation to Example C5 described above and used as such the coin type cell after it was used in the cycle test.

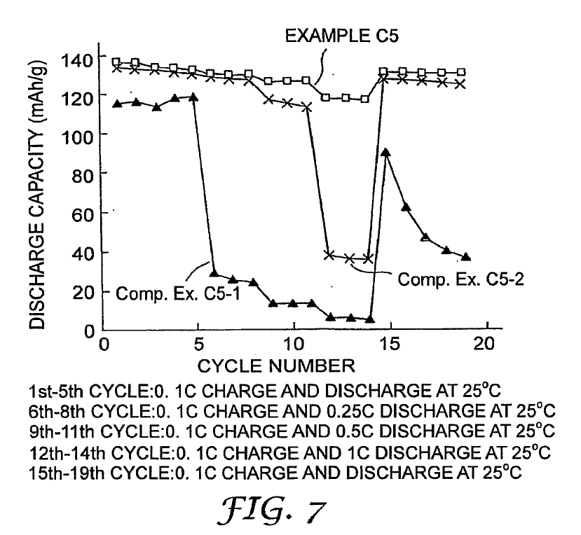

Charging was conducted at 25° C. and at a constant current corresponding to 0.1 C with respect to the theoretical capacity calculated from the weight of lithium cobalt oxide after 0.1 C charge/discharge (19^{th} cycle) was complete. Charging was completed when the cell voltage reached 4.2 V and a break was given for 10 minutes. Next, after the temperature was lowered to 0° C., discharging was conducted at a constant current corresponding to 0.1 C and was completed when the cell voltage reached 3.0 V, followed then by a break for 10 minutes. The temperature was then raised again to 25° C. The operations described above constituted one cycle and were repeated 3 cycles. Subsequently, charge/discharge cycles of 3 cycles in the same way as above with the exception that the temperature was changed to 25° C. After 6 cycles in total of the charge/discharge cycles were conducted, the discharge capacity in each cycle was determined. There was obtained a graph plotted in FIG. 7. It could be understood from the relation between the number of cycles and the discharge capacity shown in the drawing that the secondary cells using the solvent compositions of the invention for the non-aqueous electrolyte were excellent in the low temperature characteristics.

### Comparative Example C6

The procedure of Example C6 described above was repeated. In this example, the coin type cell (using the non-aqueous electrolyte consisting of 0.9 L of PP13, 0.1 L of VC and 0.5 mol of LiTFSI) used for the cycle test in Example C5-2 was as such used for comparison. After 0.1 C charging/discharging (19^{th} cycle) was complete, the discharge capacity was determined in accordance with the means described in Example C6 and a graph plotted in FIG. 7 was obtained. It could be understood from the relation between the number of cycles and the discharge capacity shown in the drawing that the secondary cells using the solvent compositions of this example for the non-aqueous electrolyte could not avoid a remarkable drop of the charge/discharge characteristics in 20th to 22^{nd} cycles because they were inferior in the low temperature characteristics.

1. A solvent composition comprising an ionic liquid and a halogenated solvent, wherein:
said ionic liquid has a molecular structure in which a cation and an anion are contained as a pair, and which liquid has a melting point of 100° C. or below;
said halogenated solvent contains at least a fluorine atom as a halogen atom, has a halogenation degree of not greater than 87%, and contains at least one partially halogenated alkyl group and/or at least one partially halogenated alkylene group; and
said solvent composition is under a single phase and in a substantially uniform state at 25° C.

2. A solvent composition as defined in claim 1, wherein said halogenated solvent is at least one compound selected from the following groups:
(a) a compound expressed by the formula
R₁OR₂
where each of R₁ and R₂ independently represents a straight or branched chain alkyl group or partially halogenated alkyl group of C1 to C10, whereby the halogen atom is selected from the group consisting of a fluorine atom, a chlorine atom, an iodine atom and a bromine atom;
(b) a compound expressed by the formula
R₃O(R₄O)p(R₅O)qR₆
where each of R₃ and R₆ independently represents a straight or branched chain alkyl group, partially halogenated alkyl group or completely halogenated alkyl group of C1 to C10,
each of R₄ and R₅ independently represents a straight or branched alkylene group, partially halogenated alkylene group or completely halogenated alkylene group of C1 to C10, whereby the halogen atom of the halogenated alkyl and alkylene groups is selected from the group consisting of a fluorine atom, a chlorine atom, an iodine atom and a bromine atom,
each of p and q is independently 0 or an integer of 1 to 10, but they do not simultaneously represent 0;
(c) a compound expressed by the formula
A(OR₇)m
where R₇ independently represents a straight or branched chain alkyl group, partially halogenated alkyl group or completely halogenated alkyl group of C1 to C10, the halogen atom of said halogenated alkyl group is selected from the group consisting of a fluorine atom, a chlorine atom, an iodine atom and a bromine atom,
A represents a divalent to tetravalent hydrocarbon group, partially halogenated hydrocarbon group or completely halogenated hydrocarbon group of C1 to C8, the halogen atom of said halogenated hydrocarbon group is selected from the group consisting of a fluorine atom, a chlorine atom, an iodine atom and a bromine atom,
and m is an integer of 2 to 4; and
(d) partially halogenated, straight chain, branched chain or cyclic alkanes having 4 or more carbon atoms.

3. (canceled)

4. An electrochemical device comprising the solvent composition claim 1 as a non-aqueous electrolyte.

5. An electrochemical device of claim 4, wherein said non-aqueous electrolyte comprises an ion dissociable compound as a support electrolyte.

6. An electrochemical device of claim 5, wherein said ion dissociable compound is a lithium salt.

7. An electrochemical device of claim 4, which is a lithium type cell comprising a positive electrode, a negative electrode and said non-aqueous electrolyte.
